(19) United States
(12) Patent Application Publication
(10) Pub. No.: US 2009/0150809 A1
(43) Pub. Date: Jun. 11, 2009

(54) PINPOINT BROWSER

(75) Inventor: Martin Hirsch, Berlin (DE)

Correspondence Address: INTELLECTUAL PROPERTY / TECHNOLOGY LAW, PO BOX 14329, RESEARCH TRIANGLE PARK, NC, 27709, US

(73) Assignee: SEMGINE GMBH, Berlin (DE)

(21) Appl. No.: 11/951,294

(22) Filed: Dec. 5, 2007

(51) Int. Cl. G06F 3/048

(52) U.S. Cl. 715/764

(57) ABSTRACT

The present invention relates to a computer aided method and an apparatus for a comfortable and optimum display of activatable information elements in an interaction window and associated information portions in a result window on a graphics display device. The associated information portions result from a search operation. The activatable information elements are, for example, key words and part of a specific theme or area. The information portions are, for example, abstracts of documents such as scientific publications that relate to the respective key words.

### FIELD OF THE INVENTION

The present invention relates to a computer aided method and an apparatus for a display of activatable information elements in an interaction window and associated information portions in a result window on a graphics display device. The associated information portions are generated from a search operation. The activatable information elements are, for example, key words and/or sections of a specific theme or area. The information portions are, for example, abstracts of documents (such as scientific publications) that relate to the respective key words.

### BACKGROUND OF THE INVENTION

Due to the massive increase of information and the variety of information sources in many areas, such as in science, there is a need to get a quick and subject-specific overview of the available information for a user browsing the information on an information providing system (such as an electronic data processing apparatus). In order to handle the vast number of information sources, in particular electronic documents, stored in large databases, key words are extracted from these electronic documents. The key words represent in a compressed manner the content of the electronic documents. Therefore, the manner of display, of the extracted information representing the information sources becomes increasingly important to maintain an overview about the available information sources.

### BRIEF DESCRIPTION OF THE RELATED ART

In one prior art example, software programmers have developed help systems to try and visually organize the help text of their software programs. The help systems offer many functions in a more or less structured and systematic manner within so-called “help browser windows” or simply “help browsers”. An example of such a context-sensitive help browser or help system is known from the mathematical software package “Mathematica®” from Wolfram Research, Inc. The Mathematica® help browser is a context sensitive help system with access to a database of information. Several scrollable column menu objects, i.e. menus of column type, contain key words in a multi-row arrangement. Each one of the key words represents a specific mathematical theme and remains unchanged. In other words, the same set of key words within a column menu object is always displayed. There is no modification of the key words to correspond more exactly to the user's request. A key word of a left, i.e. first, column menu object can be selected with a mouse pointer by the user. After the activation of the selected key word has occurred by a click on a mouse button, several further key words that are associated with the selected key word are displayed in a further column menu object of multi-row type. Once the last key word in a last column menu object has been selected and activated then an information page about the desired mathematical theme is read from the help database and displayed in an output window below the column menu objects. However, such a help system does not provide functionality that allows the integration and display of information which results from a dynamic search operation conducted when the user requests the information. In this case, the information will change from search to search. The prior art system lack the facility for providing a dynamic and configurable display of merely a portion of the searched information. Further, the column menu objects are not configurable according to a criterion relating to the importance of the respective displayed key words.

Another method of displaying information is, for example, known from the software program Microsoft® Paint. This program provides, in its help window for the documentation of its functionalities, lists of selectable and activatable key words in a cascaded manner. A user may click one first key word in a first window. Then, further clickable key words are displayed indented and are selectable in this same first window area. The key words are displayed in a cascaded manner. The further key words are displayed in an indented manner and can further be selected and activated. The key words and their hierarchy is always static and thus does not change during the user's search. The help text which is associated with each key word or arrangement of key words is then displayed in a second window area. Depending on the activation of the key words, the corresponding help text is updated after each selection or activation of a key word.

In view of the above, it would be desirable to have a graphical display system, which guides a user systematically to desired dynamically changing information or information sources on the basis of key words or combinations of key words the user want to get more information thereof.

### SUMMARY OF THE INVENTION

The present invention provides a method for generating a graphics display of at least one interaction object and at least one display object on at least one display device. The at least one interaction object comprises a plurality of activatable elements. The method comprises executing at least one search operation for generating at least one of the plurality of activatable elements. The method further comprises displaying at least a first function area of the at least one interaction object. The first function area contains the least one of the plurality of activatable elements. The at least one of the plurality of activatable elements is associated with a search result generated from the search operation. The method further comprises displaying the at least one display object comprising at least one information portion. The at least one information portion is associated with the at least one of the plurality of activatable elements. The method further comprises selecting the at least one of the plurality of activatable elements. The method further comprises generating a revised view or at least one revised view of the at least one display object in accordance with the at least one of the plurality of activatable elements.

The at least one display device can be, for example, a monitor, a plasma display, a video projector, a liquid crystal display (LCD) or any other device for the display of information. The at least one interaction object and/or the at least one display object can be, for example, a window within a graphical user interface of an operating system, like Microsoft® Windows, Linux, etc. The window can be adjustable in its size and shape. The method according to the present invention further can adapt displayed content of the window in dependence of the size of the window, for example, the size of textual and/or graphical symbols and elements.

An interaction object can be a window with displayed activatable elements. The user may interact with the displayed activatable elements, for example, graphically with the help of a navigation device (such as a computer mouse or a push-able track ball) and a corresponding graphical navigation symbol or element. In one aspect of the invention, the interaction object is a column object with one or more rows where the activatable elements are displayed. In another aspect of the invention, the column object may be scrollable. The graphical navigation symbol or element may be associated with the navigation device and its operation. An activatable element can be a displayed and/or highlighted key word. The key word may represent or be associated with, for example, an electronic document such as an electronic scientific publication file, video file, audio file, etc. The key words can be the result of a query of a user to a search engine, i.e. the result of a search operation.

The at least one information portion can be, for example, an abstract or an extract from an electronic document. In an example of the present invention, the one or more key words are displayed within the window of the first function area. As already mentioned, the first function area can be a scrollable multi-row dialog object of column-type. The one or more key words in the scrollable multi-row dialog object can be selected and/or activated through the operation and/or navigation of a navigation device. The navigation device is guided through a user of a computer system that executes the method according to present invention. Generating a revised view of the at least one display object in accordance with the at least one of the plurality of activatable elements can be, for example, the update of a result window on which relevant information is displayed correspondingly. The update of the result window can comprise blending out one or more specific information portions that may not fulfill a display criterion or a criterion that specifies the meaning, frequency, etc. of each searched activatable element, i.e. key word. The relevant information is associated with the displayed selectable and/or activatable elements, i.e. key words, in the interaction object.

As already mentioned, the method according to the present invention allows an improved interaction between an interactive information providing system or apparatus and a user by displaying substantially relevant information. The method provides an increased usability due to the simple and intuitive use of the system or apparatus. The method according to the present invention allows, for example, obtaining a quick overview of relevant documents for a specific theme. A user who wants to get more information about this specific theme uses the method as a tool for systematic and target-oriented guiding through a plurality of available information sources that are associated with a query term. The method can be regarded as a graphical front end of an information providing system that has access to electronic text documents and to a search engine. The electronic text documents can be stored locally or distributed over a communications network, such as an intranet or the Internet. Using the method of the present invention leads to a more comfortable and clear display of information. Due to the interaction of an interaction element (input window) with an display object (result window), wherein the display object is updated every time the user interacts within the interaction object, information of interest will be displayed on the display device.

In accordance with a further aspect of the invention, generating the revised view may further comprise suppressing the at least one information portion not containing the selected at least one of the plurality of activatable elements. The suppression can be carried out, for example, by blending out abstracts of documents or publications that do not have a relationship or do not contain the one or more selected key words in one scrollable multi-row dialog object. This implies that the display of information sources that have little or no relevance for a user is prevented. This leads further, for example, to a better overview for a user over the displayed information and its relevance.

According to another aspect of the present invention, the method can further comprise displaying at least a second function area within the at least one interaction object. The second function area can contain at least a further one of the plurality of activatable elements. The at least further one of the plurality of activatable elements is associated with the at least one of the plurality of activatable elements and the result of at least one search operation. The further one of the plurality of activatable elements can result from the previous search operation or a new search operation. The at least second function area can be, similar to the at least first function area, a scrollable column dialog object, i.e. a scrollable column menu with a plurality of rows.

In accordance with a further aspect of the invention, the method may further comprise defining at least one query object. The at least on query object may be a single key word or a combination of several key words that are associated logically with “AND”, “OR” operators or arbitrary combinations thereof. This allows for example, the formulation of a more specific query object to get more specific results.

According to a further aspect of the invention, the at least one of the plurality of activatable elements can be associated with the at least one query object. The query object may be, for example, one term or a combination of terms. The association between the activatable elements and the query object allows, for example, that only relevant activatable elements are displayed and thus the user need not to navigate through inessential displayed activatable elements that have little in common with the query object.

According to a further aspect of the invention, the at least one of the plurality of activatable elements may be displayed in accordance with a first display criterion. This leads, for example, to a more improved and optimized display of the activatable elements.

In accordance with a further aspect of the present invention, the at least one first function area can be a multi-row object of column-type. The multi-row object may be alternatively scrollable. This leads, on the one hand to a more compact display of relevant information and on the other hand to a more comfortable operation with the first function area.

According to another aspect of the invention, the at least one of the plurality of activatable elements can comprise an activatable button.

In accordance with a further aspect of the invention, the at least one of the plurality of activatable elements may comprise at least one graphical element. The at least one graphical element may be for example a coloured filled circle indicating the meaning or the frequency of an activatable element within a number of searched information sources, wherein the activatable element is associated with a query object.

According to another aspect of the invention, each one of the plurality of activatable elements may be activatable by at least one movable navigation element. The at least one movable navigation element may be, for example, a mouse pointer. This leads to a rapid operation of the inventive method for generating a graphics display.

In accordance with a further aspect of the invention, the first display criterion may be selected from the group consisting of an alphabetical order of the search result, a weighting of the search result or a frequency of the search result.

According to a next aspect of the invention, the at least one query object can comprise at least one term.

In accordance with a further aspect of the invention, the at least one movable navigation element may be selected from the group consisting of cursor or pointer.

According to a further aspect of the invention, the at least one interaction object can be selected from the group consisting of menu, dialog box, pop-up window, bar, toolbar, palette, ribbon or other visual interface.

In accordance with another aspect of the invention, the at least one display object may be selected from the group consisting of menu, dialog box, pop-up, bar, toolbar, palette, ribbon or other visual interface.

In accordance with another aspect of the invention, an apparatus is provided for generating a graphics display which implements the method as discussed above. The apparatus comprises at least one at least one display device for displaying the graphics display. The apparatus also comprises at least one search engine for the execution of at least one search operation for the generation of at least one of the plurality of activatable elements. The apparatus further comprises at least one display generation engine for generating the graphics display with at least a first function area of the at least one interaction object and the at least one display object on the display device and revising the graphics display on actuation of the at least one of the plurality of activatable elements. The apparatus further comprises at least one selection engine for selecting the at least one of the plurality of activatable elements.

In accordance with another aspect of the invention, there is provided a computer readable tangible medium which stores instructions for implementing the method according to the invention run on a computer. The instructions control the computer, i.e. the electronic data processing apparatus, to perform the process of serialising a plurality of information elements as discussed previously. The computer readable tangible medium can be, for example, a floppy disk, CD-ROM, DVD, USB flash memory or any other kind of storage device. Alternatively, the instructions for implementing and executing the method according to the present invention can be downloaded via a communications networks such as intranets, the Internet, etc. In an alternative aspect of the invention, the instructions for implementing and executing the method according to the present invention can be stored on a mobile communication device with access to a communications network such as a mobile phone, etc.

In accordance with a further aspect of the invention, a computer program product is provided. The computer program product is loadable into at least one memory of a computer readable tangible medium or into an electronic data processing apparatus. Such an apparatus can be, for example, an apparatus as described above. The computer program product comprises program code means to perform the serializing of a plurality of information elements as discussed previously.

These together with other possible and exemplary aspects and objects that will be subsequently apparent, reside in the details of construction and operation as more fully herein described and claimed, with reference being had to the accompanying figures.

Further, it is clear for the man skilled in the art that the disclosed characteristics and features of the invention can be arbitrarily combined with each other.

### BRIEF DESCRIPTION OF THE DRAWINGS

FIG. 1 is an example of the graphics display according to the present invention in a first phase;

FIG. 2 is an example of the graphics display according to the present invention in a second phase;

FIG. 3 is an example of the graphics display according to the present invention in a third phase;

FIG. 4 is an example of the graphics display according to the present invention in a fourth phase;

FIG. 5 is a flowchart of an example of the method according to the present invention;

FIG. 6 is a schematic representation of an example of an apparatus for performing the method according to the present invention.

### DETAILED DESCRIPTION OF THE INVENTION

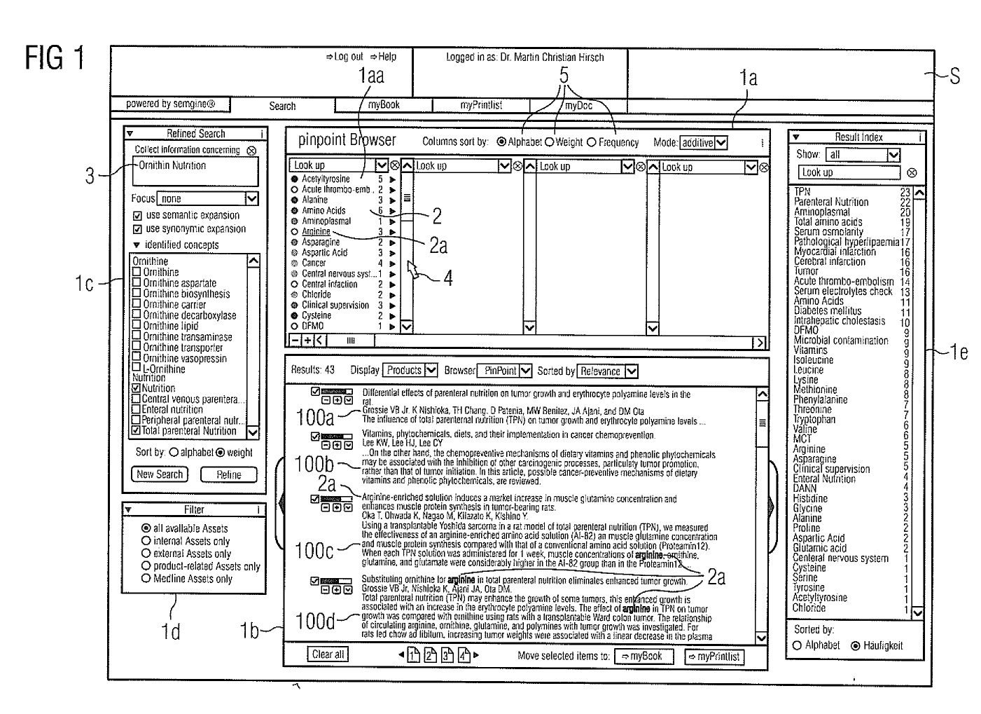

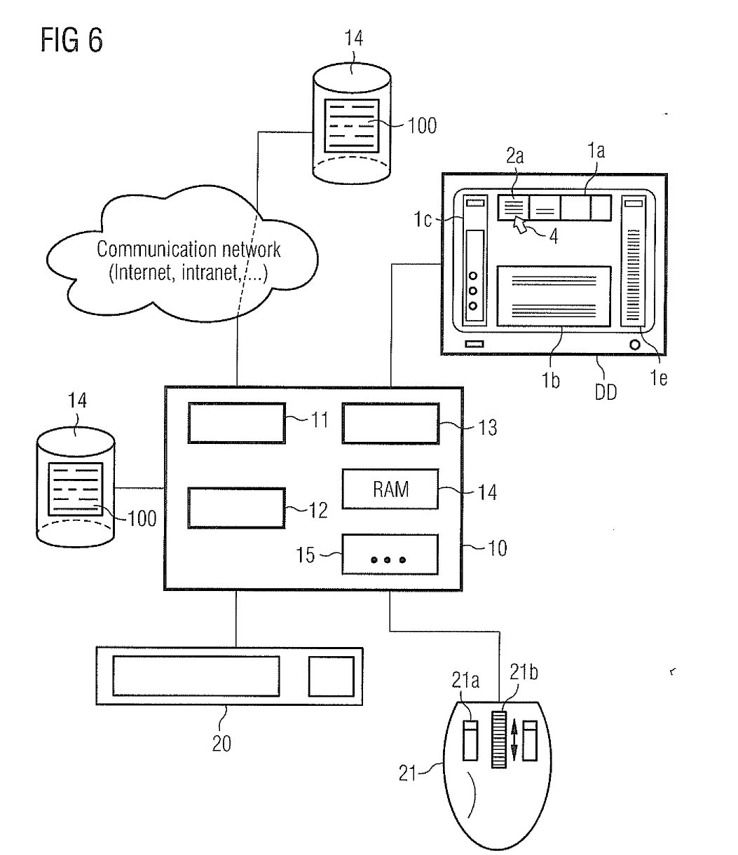

FIG. 1 is an example of the graphics display on a display device DD (see FIG. 6) when the method according to the present invention is executed on an electronic data processing apparatus 10 (see FIG. 6). The graphics display of FIG. 1 represents results of the method in a first phase or first stage as displayed on the display device DD. This aspect will be described further in detail in the following.

FIG. 1 shows a first interaction object 1a, a display object 1b, a second interaction object 1c, a third interaction object 1d and a fourth interaction object 1e as well as a status bar S. The status bar S contains information about the user of the method according to the present invention and miscellaneous information, for example, the software application in which the method according to the present invention is implemented or for which the method is executed.

The method of the present invention is computer assisted, i.e. the method runs on an operating system with a graphical user interface. Thus, the method of the present invention can be implemented and executed on all graphical oriented operating systems such as Microsoft® Windows, Linux, Mac OS, etc.

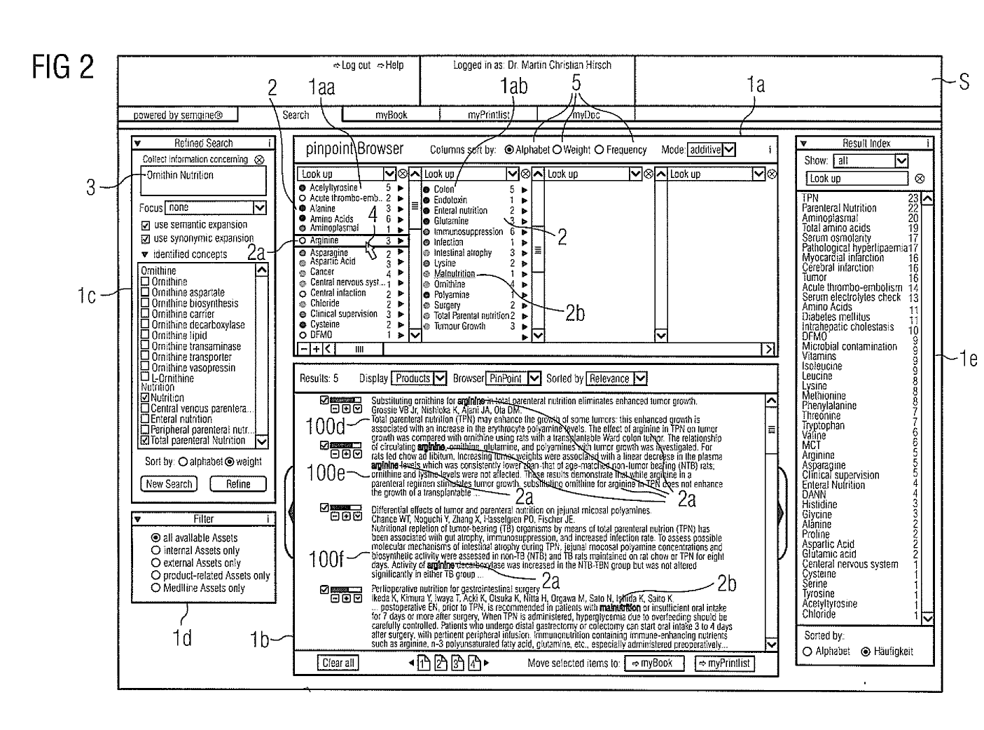

The second interaction object 1c is displayed as an input window at which the user can enter information in the form of terms (or key words) and click one or more options to start and/or further control the method according to the present invention. It should be noted at this point that the third interaction object 1d and the fourth interaction object 1e operate in the same manner as the second interaction object 1c. Since the third interaction object 1d and the fourth interaction object 1e, i.e. their functionalities and features, are merely further desirable features of the invention but are not essential to the operation of the invention, the characteristics and features of third interaction object 1d and the fourth interaction object 1e will not be described here in detail. This also applies to the description in conjunction with the further FIGS. 2 to 4.

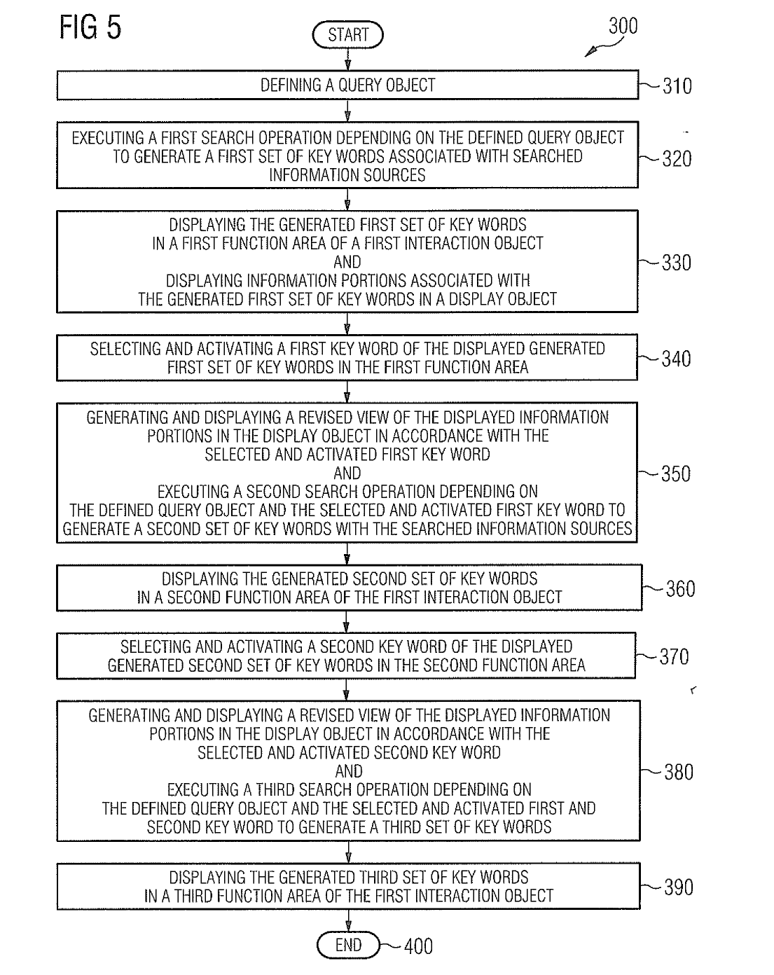

FIG. 5 is an exemplary flowchart of the method of the present invention The method is started at start 300 by defining in step 310 at least one query object 3. The query object 3 is displayed in the second interaction object 1c and is shown in FIGS. 1 to 4. The query object 3 can be one single term or a combination of terms. Several terms can also be associated with each other through combinations with the logical operators “AND” and “OR”. The example of query object 3 as displayed in FIGS. 1 to 4 in the second interaction object 1c is the term “Ornithin Nutrition” which is a query object representing an alkaline amino acid.

The second interaction object 1c is displayed as a window with an input area at which the query object 3 can be entered by the user. The entered query object 3 is displayed within a frame in the second interaction object 1c. The query object 3 represents a specific theme about which the user wants to know more information or information sources. The query object 3 can be entered via an input device such as keyboard 20 (as shown in FIG. 6). In addition, further information concerning “identified concepts” can be selected from a menu object that is also displayed within the second interaction object 1c to more clearly specify the one or more search parameters. A pointing device like a computer mouse 21 (see FIG. 6) can be used to control and guide the method of display according to the invention. The computer mouse 21 in conjunction with the makes the invention easy to use. The computer mouse 21 is shown on the display device by a movable navigation element which in this example is a mouse pointer 4 of arrow type. Alternatively, the movable navigation element can be a cursor element.

As mentioned before, the method of the present invention can be started by defining in step 310 the query object 3. The method is further continued by the user moving the mouse pointer 4 to the “New Search” button displayed in the second interaction object 1c and subsequently activating this “New Search” button. The activation of the “New Search” button is carried out through a click on a mouse button 21a of the computer mouse 21.

In an alternative aspect of the invention, the query object 3 can be selected from a plurality of displayed activatable elements 2, i.e. key words. The selection is carried out with the help of the operation of the movable navigation element (such as the mouse pointer 4). The plurality of displayed activatable elements 2 will have been generated if the method of the present invention had previously performed at least one search operation. The results of the previously performed search operation are shown at least in the first function area 1aa including at least one activatable element 2a is displayed. The user selects one or more of the displayed activatable elements 2a of interest using a corresponding hot key or key combination or mouse pointer 4 and the one or more selected activatable element 2a is used as a new query object 3 together with the initial query object 3.

Once the query object 3 has been defined in step 310 then a search operation 320 is executed using the defined query object 3 in order to generate one or more activatable elements 2. The one or more activatable elements 2 will typically be a first set of key words 2. The search operation 320 is implemented as a search algorithm. The search algorithm uses the defined query object 3 as an input parameter and tries to find information or information sources 100 that are more or less associated with the defined query object 3 in a manner that is known by the skilled person and not described in detail herein. A number of the search algorithms can be used and this invention is not limited to any one of the search algorithms. It is clear for the person skilled in the art that also the activatable elements 2 are associated with the query object 3.

The search operation 320 is executed and a first list of activatable elements 2, i.e. activatable key words, is generated. Each one of the key words 2 represents a content of a portion or a complete information source (see FIG. 6). Each information source is an electronic text document 100 such as a scientific publication, web site, URL-Link, etc. The electronic text documents 100 are stored in databases 14 (see FIG. 6). The databases 14 can be present locally or distributed over a communication network such as an intranet or the Internet (see FIG. 6).

After the first set of key words 2, resulting from the first search operation 320, has been generated, then the first set of key words 2 is displayed at step 330 as a list of activatable key words 2 in a first function area 1aa (see FIGS. 1 to 4). The first function area 1aa is displayed within the first interaction object 1a as a scrollable, multi-row menu object of column-type. The term “multi-row” means that each row contains one activatable element 2. In other words, the display of the first set of key words 2 within the first function area 1aa can be controlled, for example, by operating a scroll wheel 21b on the computer mouse 21. The first set of key words 2 in the first function area 1aa are displayed in accordance with a first display criterion 5. One example of the first display criterion is a sorting of the key words. Thus, the key words 2 can be displayed in a sorted manner, i.e. in an alphabetical order or according to their weight in the searched information sources 100 or according to their frequency in the searched information sources 100. However, other display criterion 5 could be adopted.

Each of the key words 2 in the first function area 1aa is displayed together with a graphical element such as a color filled circle to further indicate, for example, a relevancy of the respective key word 2 with regard to the defined query object 3. In other words, the relevancy represents the intensity of the relationship of a key word 2 to the query object 3. Each displayed key word 2 is selectable and activatable by the movable navigation element, i.e. the mouse pointer 6. The activation of one or more key words 2 can be, as already mentioned, performed with a click on the corresponding mouse button 21a of a computer mouse 21 (see FIG. 6).

At nearly the same time as the key words 2 are displayed in the first function area 1aa then portions (such as abstracts or extracts) from the corresponding searched information sources 100 are displayed in the display object 1b at 330 (see FIG. 5). The display object 1b (see FIG. 1) is a result window with regard to the information portions 100a, 100b, 100c, 100d. The display object 1b is displayed as a scrollable window. Both the first interaction object 1a and the display object 1b and also the further interaction objects 1c, 1d, 1e can be arranged as a menu, dialog box, pop-up window, bar, toolbar, palette, ribbon or other displayable visual interface.

At step 340 (see FIG. 5), the user of the method according to the invention may be interested in electronic text documents 100 that include the term “Arginine” (an alpha-amino acid) and which are already been selected during the search for the term “Ornithin Nutrition”. “Arginine” is one of the displayed first set of key words 2 in the first function area 1aa. The user moves the computer mouse 21 such that the displayed mouse pointer 4 on the display device DD moves from its previous position outside the first function area 1aa (see FIG. 1) to the displayed term “Arginine” within the first function area 1aa (see FIG. 2). When the mouse pointer 4 has moved over the key word 2a “Arginine” then the key word 2a is displayed highlighted as an activatable button (see FIG. 2).

When the key word 2a, i.e. the displayed term “Arginine”, is selected via the mouse pointer 4 and activated by a click on the corresponding mouse button 21a at the computer mouse 21 then a revised view of the display object 1b (see FIG. 2) is generated and displayed on the display device DD. In other words, only those information portions 100d, 100e and 100f are displayed in the display object 1b that include the key word “Arginine” and that are associated with the query object 3 “Ornithin Nutrition” (see FIG. 2). The remaining information portions 100a, 100b which do not contain the selected and activated key word 2a, “Arginine”, are suppressed in the revised display object 1b. This leads to a display according to which only user relevant information is displayed.

In addition, a new, i.e. second, search operation is executed. The input parameter for the second search operation is then changed from the original term query object 3 itself to a modified query object 3 comprising the query object 3 (i.e. the term “Ornithin Nutrition”) and the selected key word 2a “Arginine”. In other words, the selected and activated key word 2a “Arginine” is combined with the term “Ornithin Nutrition” using the logical operator “AND”. In an alternative aspect of the invention, more than one key word 2a of interest can be selected from the first function area 1aa. This can also apply to a displayed further set of keywords 2 in the further function areas 1ab, 1ac and 1ad.

The new search operation with the modified query object 3 “Ornithin Nutrition AND Arginine” leads to the generation of a second set of key words 2. This second set of key words 2 is a subset of the first set of key words 2. In other words, the second set of key words 2 is more specific since the modified query object 3 is more detailed.

At 360, the generated second set of key words 2 is displayed in a second function area 1ab within the first interaction object 1a. The second function area 1ab is, similar to the displayed first function area 1aa, displayed within the first interaction object 1a as a scrollable, multi-row menu object of column-type. The displayed second set of key words 2 in the second function area 1ab are also displayed in accordance with the first display criterion 5 as described above. The second function area 1ab is displayed on the right side of the first function area 1aa to provide an optimum usability and guidance of the user is in cascaded manner.

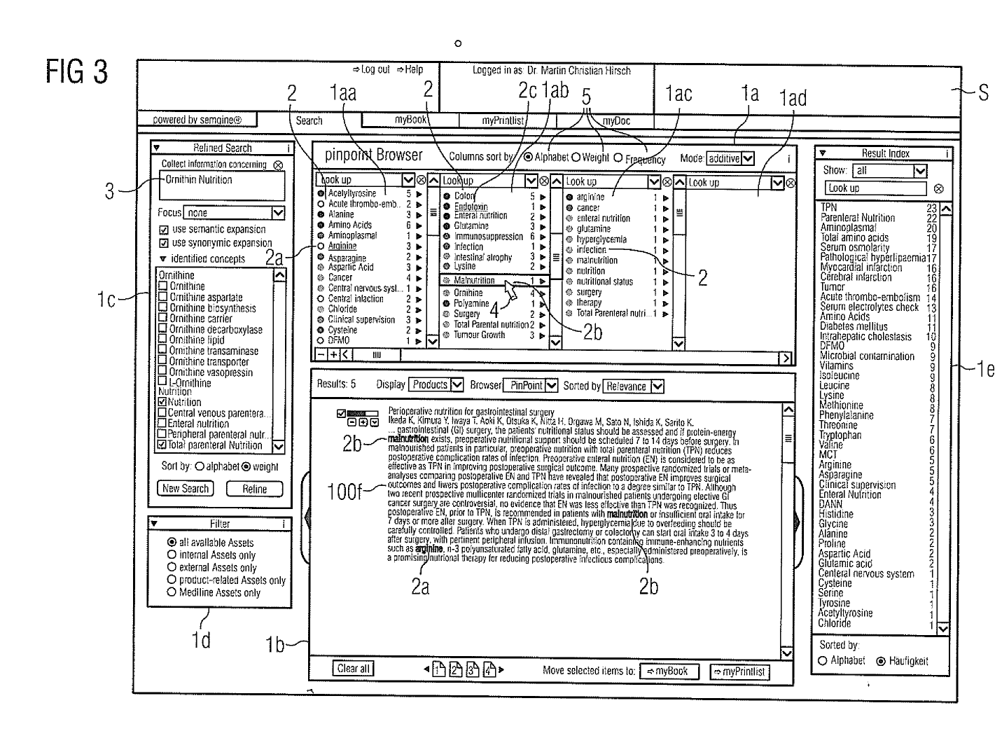

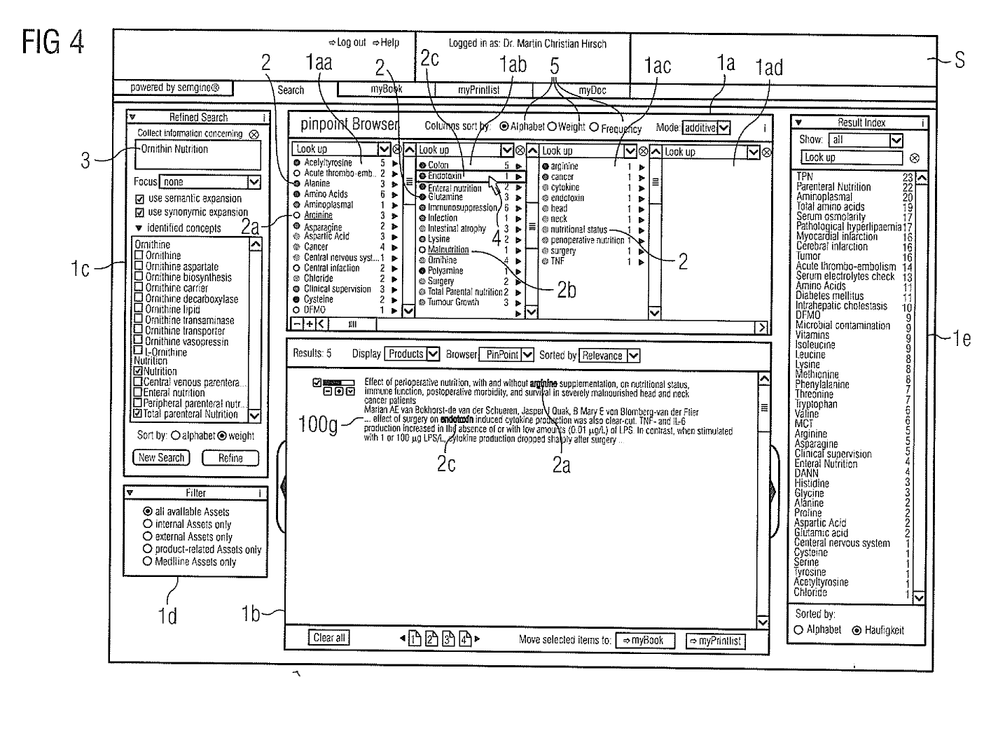

The method of the present invention can now be optionally continued at step 370 if the user selects and activates a further, second key word 2b or 2c of interest in the second function area 1ab as it is shown in FIG. 3 or FIG. 4. As it can be seen in FIG. 3, the second key word 2b that is of interest is “Malnutrition”. Alternatively, the selected second key word 2c in the second function area 1ab in FIG. 4 is the displayed term “Endotoxin”. The displayed second key word 2b, 2c can be selected and activated in the same manner as described above.

As already described above, when the second key word 2b or 2c, i.e. the displayed term “Malnutrition” or “Endotoxin”, is selected via the mouse pointer 4 and activated by a click on the corresponding mouse button 21a at the computer mouse 21, then a revised view of the display object 1b (see FIG. 3 and FIG. 4) is generated and displayed on the display device DD. In other words, only those information portions 100f (see FIG. 3 in case of the selection and activation of the key word 2b) or 100g (see FIG. 4 in case of the selection and activation of the key word 2c) are displayed in the display object 1b that further include the key word “Malnutrition” or “Endotoxin” and that are associated with the query object 3 “Ornithin Nutrition” (see FIG. 2) and the selected and activated first key word 2a “Arginine”. The remaining information portions 100a to 100e which do not contain the selected and activated first key word 2a, “Arginine” and which do not contain the selected and activated second key word 2b or 2c are suppressed in the revised display object 1b. This leads to a display according to which only user relevant information is displayed.

A new, i.e. third, search operation is executed again. The input parameter for the third search operation is then changed from the previous query object 3 itself to the query object 3, i.e. the term “Ornithin Nutrition”, and the selected key word 2a “Arginine” and the selected key word 2b or 2c. As described above, the terms are associated with each other with the logical operator “AND”.

The third search operation with the modified new query object 3 “Ornithin Nutrition AND Arginine AND Malnutrition” (in the case as presented in FIG. 3) leads to the generation of a third set of key words 2. This third set of key words 2 can be regarded as a further subset of the first set of key words 2 and the second set of key words 2. In other words, the third set of key words 2 is even more specific since the query object 3 for the third search operation is even more detailed.

At step 390, the generated third set of key words is displayed in a third function area 1ac within the interaction object 1a. The third function area 1ac has the same features as described for the first or second function area 1aa and 1ab. Since only one information portion 100f or 100g, representing respectively one electronic text document 100, is displayed in the revised display object 1b then the method is finished at 400.

As it can be seen from FIGS. 1 to 4, the user has further the possibility to select a further, i.e. third key word of interest in the third function area 1ac. This leads to the execution of a further, i.e. fourth search operation and the generation of a fourth set of key words 2 in the fourth function area 1ad within the interaction object. In conjunction thereto, a revised view of the display object 1b is generated and displayed. Then the revised display object 1b displays only information portions that are associated with the initial query object 3 “Ornithin Nutrition” and that include the selected first, second and third key word 2.

FIG. 6 shows an example of a schematic representation of an apparatus 10 for performing the method according to the invention. The apparatus 10 can be, for example, an electronic data processing apparatus such as a personal computer, a server, a web-server, a terminal, a PDA, etc. with access to at least one electronic text document 100, i.e. information source database and/or to a mobile communications network with access to electronic information sources such as downloadable text documents, web pages, etc.

Further, the apparatus 10 can be a mobile communications device such as a mobile phone, a smart phone, etc. The apparatus 10 can also be, for example, part of a electronic data processing apparatus such as a server, personal computer, PDA, laptop, etc. or a mobile telephone or any kind of electronic apparatuses for communication or with access to a storage device or a communications network storing or providing one or more information sources as described above.

The apparatus 10 as it can be seen in FIG. 6 comprises at least one display device DD for displaying the graphics display, i.e. the results and the interaction with the method of the present invention. The at least one display device DD can be, for example, a monitor, a plasma display, a video projector, a liquid crystal display (LCD) or any other device for the display of information.

Further, the apparatus 10 comprises a search engine 11 for the execution of the one or more search operations in order to generate the one or more set of key words depending on the number of selected and activated key words 2 in the respective function areas 1aa to 1ac. The search engine 11 has access to locally or externally stored electronic text documents 100. The electronic text documents 100 may be stored within databases 14.

In addition, the apparatus 10 according to the present invention comprises a display generation engine 12 for generating the graphics display at the display device DD. The display generation engine 12 generates the display of the interaction objects 1a, 1c, 1d, 1e and the displayed object 1b. Further, the display generation engine 12 generates the revised graphics display, in particular of the display object 1b, on actuation, i.e. selection and activation, of at least one activatable element 2 that is displayed in at least one function area 1a, 1b, 1c, 1d within the interaction object 1a.

The apparatus 10 as it can be seen in FIG. 6 further comprises a selection engine 13 for the selection of at least one activatable element, i.e. key word, that is displayed on the display device DD.

The apparatus 10 may an electronic data processing apparatus and thus be realized in hard and/or software. Consequently, the engines of the apparatus 10, as described above, are connected to each other and interact together in a known manner.

The apparatus 10 is further connected with data input devices such as a keyboard 20 and a computer mouse 21. The apparatus 10 has also access to local storage devices 14 or storage devices 14, i.e. databases storing electronic text documents 100, that can be accessed via a telecommunication network such as an intranet or the Internet.

Since the apparatus 10 is a computer it may further comprise further common and known components such as a Random Access Memory (RAM) module 14 and further components 15 such as a CD-ROM/DVD drive, a floppy drive, a hard drive, a disk controller, a ROM memory, communication ports and interfaces, a central processing unit, etc.

Since the invention has been described in terms of single examples, the man skilled in the art will recognize that the invention can be practiced with modification within the spirit and scope of the attached claims.

At least, it should be noted that the invention is not limited to the detailed description of the invention and/or of the examples of the invention. It is clear for the person skilled in the art that the invention can be realized at least partially in hardware and/or software and can be transferred to several physical devices or products. The invention can be transferred to at least one computer program product. Further, the invention may be realized with several devices.

What is claimed is:

1. A method for generating a graphics display of at least one interaction object and at least one display object on at least one display device, the at least one interaction object comprising a plurality of activatable elements, the method comprising:
executing at least one search operation for generating at least one of the plurality of activatable elements;
displaying at least a first function area of the at least one interaction object, the first function area containing at least one of the plurality of activatable elements, the at least one of the plurality of activatable elements being associated with a search result;
displaying the at least one display object comprising at least one information portion associated with the at least one of the plurality of activatable elements;
selecting the at least one of the plurality of activatable elements;
generating a revised view of the at least one display object 1n accordance with the at least one of the plurality of activatable elements;

2. The method according to claim 1, wherein generating the revised view further comprises:
suppressing the at least one information portion not containing the selected at least one of the plurality of activatable elements;

3. The method according to claim 1, further comprising:
displaying at least a second function area within the at least one interaction object, the second function area containing at least a further one of the plurality of activatable elements, the at least further one of the plurality of activatable elements being associated with the at least one of the plurality of activatable elements;

4. The method according to claim 1, further comprising:
defining at least one query object;

5. The method according to claim 4, wherein the at least one of the plurality of activatable elements is associated with the at least one query object.

6. The method according to claim 1, wherein the at least one of the plurality of activatable elements is displayed in accordance with a first display criterion.

7. The method according to claim 1, wherein the at least first function area is a multi-row object.

8. The method according to claim 7, wherein the multi-row object is scrollable.

9. The method according to claim 1, wherein the at least one of the plurality of activatable elements comprises an activatable button.

10. The method according to claim 1, wherein the at least one of the plurality of activatable elements comprises at least one graphical element.

11. The method according to claim 1, wherein each one of the plurality of activatable elements is activatable by at least one movable navigation element.

12. The method according to claim 6, wherein the first display criterion is selected from the group consisting of an alphabetical order of the search result, a weighting of the search result or a frequency of the search result.

13. The method according to claim 4, wherein the at least one query object comprises at least one term.

14. The method according to claim 11, wherein the at least one movable navigation element is selected from the group consisting of cursor or pointer.

15. The method according to claim 1, wherein
the at least one interaction object 1s selected from the group consisting of menu, dialog box, pop-up window, bar, toolbar, palette, ribbon or other visual interface.

16. The method according to claim 1, wherein
the at least one display object 1s selected from the group consisting of menu, dialog box, pop-up, bar, toolbar, palette, ribbon or other visual interface.

17. An apparatus for generating a graphics display of at least one interaction object and at least one display object,
the at least one interaction object comprising a plurality of activatable elements, the apparatus comprising:
at least one display device for displaying the graphics display;
at least one search engine for the execution of at least one search operation for the generation of at least one of the plurality of activatable elements;
at least one display generation engine for generating the graphics display with at least a first function area of the at least one interaction object and the at least one display object on the display device and revising the graphics display on actuation of the at least one of the plurality of activatable elements,
wherein
the first function area contains at least one of the plurality of activatable elements, the at least one of the plurality of activatable elements is associated with a search result and
the at least one display object comprises at least one information portion associated with the at least one of the plurality of activatable elements;
at least one selection engine for selecting the at least one of the plurality of activatable elements;

18. A computer readable tangible medium storing instructions for implementing a process driven by a computer, the instructions controlling the computer to perform the process of generation of a graphics display of at least one interaction object and at least one display object on at least one display device, the at least one interaction object comprising a plurality of activatable elements, the generation of the graphics display comprising:
executing at least one search operation for generating at least one of the plurality of activatable elements;
displaying at least a first function area of the at least one interaction object, the first function area containing the least one of the plurality of activatable elements, the at least one of the plurality of activatable elements being associated with a search result;
displaying the at least one display object comprising at least one information portion associated with the at least one of the plurality of activatable elements;
selecting the at least one of the plurality of activatable;
generating a revised view of the at least one display object 1n accordance with the at least one of the plurality of activatable elements;

19. A computer program product, being loadable into at least one memory of a computer readable tangible medium or into an electronic data processing apparatus, the computer program product comprising program code means to perform generation of a graphics display of at least one interaction object and at least one display object on at least one display device, the at least one interaction object comprising a plurality of activatable elements, the generation of the graphics display comprising:
executing at least one search operation for generating at least one of the plurality of activatable elements
displaying at least a first function area of the at least one interaction object, the first function area containing the least one of the plurality of activatable elements, the at least one of the plurality of activatable elements being associated with a search result;
displaying the at least one display object comprising at least one information portion associated with the at least one of the plurality of activatable elements;
selecting the at least one of the plurality of activatable elements;
generating a revised view of the at least one display object 1n accordance with the at least one of the plurality of activatable elements;
if the program code means are executed on the electronic data processing apparatus.
